(19) United States
(12) Patent Application Publication
(10) Pub. No.: US 2025/0314866 A1
(43) Pub. Date: Oct. 9, 2025

(54) OPTICAL CAVITY ARRAY

(71) Applicants: THE UNIVERSITY OF CHICAGO, CHICAGO, IL (US); THE BOARD OF TRUSTEES OF THE LELAND STANFORD JUNIOR UNIVERSITY, Stanford, CA (US)

(72) Inventors: David Schuster, Stanford, CA (US); Jonathan Simon, Palo Alto, CA (US); Aishwarya KUMAR, Lake Grove, NY (US); Matthew Scott JAFFE, Bozeman, MT (US); Danial SHADMANY, Scottsdale, AZ (US)

(21) Appl. No.: 18/865,293

(22) PCT Filed: May 12, 2023
(86) PCT No.: PCT/US2023/022105

§ 371 Date: Nov. 12, 2024

Related U.S. Application Data
(60) Provisional application No. 63/364,678, filed on May 13, 2022.

(51) Int. Cl. G02B 17/00; G21K 1/00

(52) U.S. Cl. CPC G02B 17/004; G21K 1/00

(57) ABSTRACT

An optical cavity array includes a plurality of mirrors that form an optical cavity, a first lens system located within the optical cavity, and a second lens system located within the optical cavity. The first lens system has a first output facing a first mirror of the plurality of mirrors and a second output facing a second mirror of the plurality of mirrors. The second lens system has a second input facing the first input and a second output facing the second mirror. The first and second lens systems are configured such that the optical cavity supports longitudinal modes that are transversely non-degenerate, forming spatially separated waists that lie along a focal plane that is axially located between the first and second inputs. When the longitudinal modes are excited, the waists may be used as an array of optical dipole traps.

### RELATED APPLICATIONS

This application claims priority to U.S. Provisional Patent Application No. 63/364,678, filed on May 13, 2022, the entirety of which is incorporated herein by reference.

### BACKGROUND

Cavity quantum electrodynamics (cQED) is the study of the interaction between light and matter inside a resonant cavity. The matter may be an atom, ion, molecule, or other type of quantum particle or emitter that couples to light. The quantum particle may be trapped near the waist of an excited mode of the cavity, giving rise to intracavity optical tweezers.

### SUMMARY

The present embodiments include an optical cavity array that may be used to create a plurality of longitudinal modes within an optical cavity. Advantageously, these longitudinal modes are transversely separated from each other, and therefore are not coupled to each other. Using lens systems, each longitudinal mode forms a respective one of a plurality of foci that coincide with a focal plane that lies within the optical cavity. Due to the transverse separation of modes, these foci are also transversely separated. Longitudinal modes with this behavior are referred to herein as transversely non-degenerate. Each focus may be used as an optical dipole trap, or optical tweezers, for trapping a quantum emitter (e.g., a neutral atom, atomic ion, molecule, etc.). The plurality of foci may therefore be thought of as forming an optical-tweezer array for trapping several quantum emitters.

The plurality of foci may be transversely separated, for example, by a few microns. These embodiments advantageously avoid the aberration sensitivity and resonator stability limitations present when many foci are generated with a degenerate resonator (also known as an “imaging resonator”). Each focus may be thought of as being generated by its own optical resonator, or cavity, having its own unique path. However, most, if not all, of the optical components are bulk. These optical-resonator paths may form an array that extends transversely to the optical axis in one or two dimensions. Each optical-resonator path of the array is independently stable and may be operated far from any mode degeneracies that would render it susceptible to mode mixing, aberration-induced instabilities, or both.

In embodiments, an optical cavity array includes a plurality of mirrors that form an optical cavity, a first lens system located within the optical cavity, and a second lens system located within the optical cavity. The first lens system has a first output facing a first mirror of the plurality of mirrors and a first input facing a second mirror of the plurality of mirrors. The second lens system has a second input facing the first input and a second output facing the second mirror. The first and second lens systems are configured such that the optical cavity supports longitudinal modes that are transversely non-degenerate. These longitudinal modes form spatially separated waists that lie along a focal plane that is axially located between the first and second inputs. When the longitudinal modes are excited, the waists may be used as an array of optical dipole traps (i.e., an optical-tweezer array) or an array of optical lattices.

### BRIEF DESCRIPTION OF THE FIGURES

FIG. 1 is a side view of an optical cavity array that forms a plurality of longitudinal modes that are transversely non-degenerate, in embodiments.

FIG. 2 is a side view of the optical cavity array of FIG. 1, showing in more detail how each of the longitudinal modes forms a respective one of a plurality of foci at a focal plane.

FIG. 3 is a side view of a polygonal mirror, in embodiments.

FIG. 4 is a side view of a polygonal mirror that is similar to the polygonal mirror of FIG. 3, in an embodiment.

FIG. 5 is a side view of a cat's-eye retroreflector array, in an embodiment.

FIG. 6 is a side view of a convex micromirror array, in an embodiment.

FIG. 7 is a side view of a retroreflector array, in an embodiment.

FIG. 8 is a side view of an optical cavity array that is similar to the optical cavity array of FIG. 1, in an embodiment.

FIG. 9 is a side view of the optical cavity array of FIG. 8, showing in more detail how foci are located at a reflective surface of a first mirror.

FIG. 10 is a side view of an optical cavity array that is similar to the optical cavity array of FIG. 1, in an embodiment.

FIG. 11 is a side view of the optical cavity array of FIG. 10, showing in more detail how foci are located at the focal plane.

### DETAILED DESCRIPTION

In cavity quantum electrodynamics (cQED), it is frequently ideal to engineer the single-particle cooperativity η to be as large as possible. Defined as η=g²/κΓ, the single-particle cooperativity η quantifies the competition between (i) coherent information exchange at rate g between a cavity and a quantum emitter (e.g., a neutral atom, ion, quantum dot, etc.) located within the cavity and (ii) the decoherence rates Γ and κ of the quantum emitter and cavity, respectively. Increasing η increases the collection probability P_{c}=η/(1+η) that the quantum emitter emits into (or absorbs from) a mode of the cavity, as opposed to free space. Increasing η also reduces the failure rate 2π/η^{1/2} of cavity-mediated quantum information transfer between two quantum emitters trapped in separate optical cavities.

Another way to express the cooperativity is η≈0.2 [symbol] λ²/w₀², where [symbol] is the cavity finesse, w₀ is the minimum diffraction-limited waist of the cavity mode, and λ is the wavelength of both the radiating transition of the quantum emitter and cavity resonance. The finesse [symbol] can be interpreted as the number of round trips that light in the optical cavity makes before lost due to absorption or transmission through a cavity mirror. This alternative expression for η can be interpreted geometrically: the resonant cross-section that a quantum emitter presents for absorption of light is ˜λ² and the area of the cavity mode going past the quantum emitter is ˜w₀². Therefore, for each pass of the cavity light past the quantum emitter, the absorption probability is ˜λ²/w₀². The optical cavity simply enhances this single-pass absorption probability by the number of passes [symbol] .

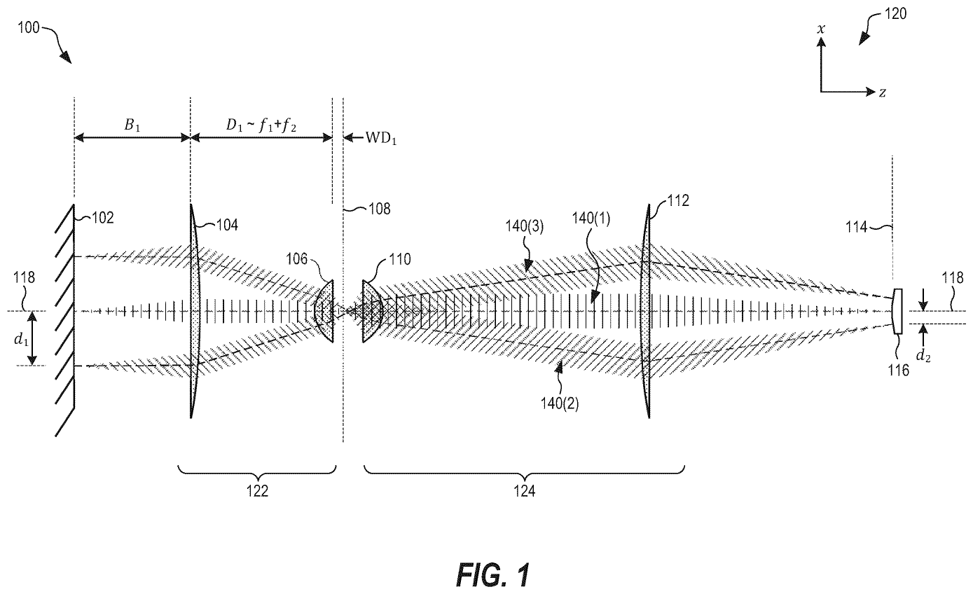

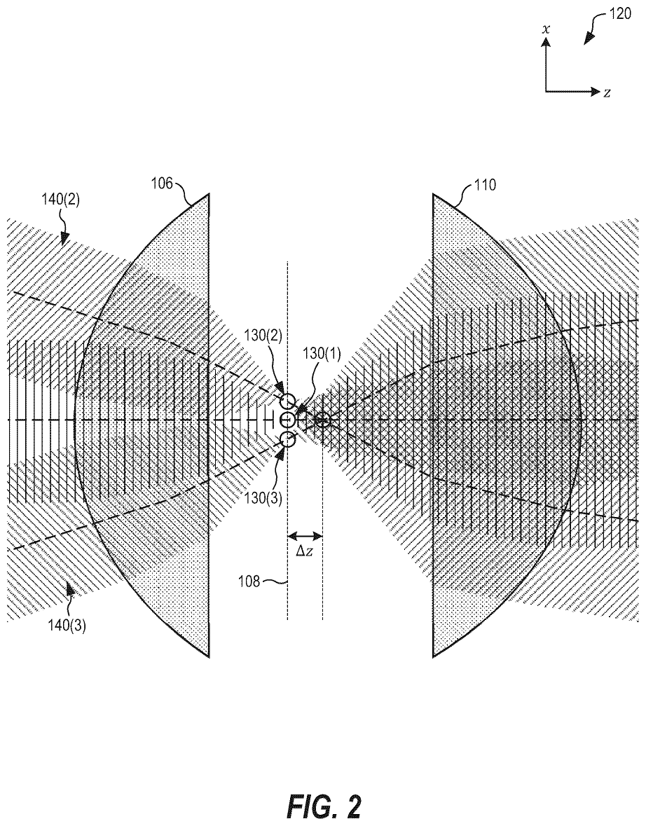

Prior-art optical cavities used for cQED achieve a high cooperativity q by employing a relatively large waist w₀ and very high finesse [symbol] . Such optical cavities (e.g., see FIGS. 1 and 2) are typically fabricated using concave mirrors having very high reflectivities, typically greater than 99.999%. The highest finesses of nearly 10⁶ have been achieved by improving superpolishing and dielectric coatings of these mirrors. Due to their high finesse [symbol] , these prior-art optical cavities are challenging to align and stabilize. Furthermore, specialized handling techniques are needed to prevent airborne particulate matter (e.g., dust) from landing on the mirror surfaces; such contamination reduces the finesse [symbol] by increasing scatter. Similarly, mounting the optical cavity inside a vacuum chamber, as needed for atom trapping, puts stringent cleanliness requirements on the vacuum system to prevent contaminants (e.g., oil) from landing on the mirrors.

One aspect of the present embodiments is the realization that increasing the single-particle cooperativity η places no significant restrictions on the cavity length L. The idea that cQED requires a small mode volume V is a misnomer that arose by writing the Purcell factor as F_{P}=3λ³Q/(4π²V). The Purcell factor F_{P} quantifies how much a quantum emitter's spontaneous emission rate is enhanced when it is located inside a resonant cavity having quality factor Q. The expression makes small mode volume V seem advantageous to increasing the Purcell factor F_{P}, but ignores the fact that the Q drops as the cavity length L decreases. What is relevant for cQED is the finesse [symbol] =Qc/2Lf_{c}, where f_{c} is the resonant frequency of the cavity mode. When written in terms of the finesse [symbol] and assuming that the mode volume V˜Lw₀², the Purcell factor F_{P} is identical, up to unit factors, to the single-particle cooperativity η and therefore only depends on [symbol] , λ, and w₀. Thus, for a fixed value of λ, the finesse [symbol] and the waist w₀ are the two independent experimental parameters that determine the cooperativity η.

The present embodiments use intracavity lenses to achieve a waist w₀ that is smaller than that achieved with the prior-art optical cavities described above. Since η∝1/w₀², the smaller waist w₀ results in a significantly larger cooperativity η that can be used to lower the finesse [symbol] . For example, the optical cavity can generate a waist of w₀≈500 nm at λ=780 nm (the D₂ transition for Rb), yielding a cooperativity of η≈9.4 for a finesse of only [symbol] =20. This value of the cooperativity η is so large that an atom trapped near the waist emits a photon ten times faster into the optical cavity than into free space. When the atom is implemented as a qubit, the emitted photon has a greater-than-90% change of being collected by the optical cavity. Furthermore, due to the lower finesse [symbol] , the cavity length L only needs to be stabilized to within λ/(2 [symbol] )=λ/20, making the optical cavity easier to align and stabilize than prior-art optical cavities. Also due to the lower finesse [symbol] , additional optical components can be placed within the cavity without significantly degrading the finesse [symbol] . The lower finesse [symbol] also eases requirements on handling, assembly, and vacuum cleanliness since an increase in optical scatter off of surface contaminants no longer significantly degrades the finesse [symbol] .

The increase in photon collection probability P_{c} will substantially improve state detection of cQED setups and other systems that use optical-tweezer arrays. Accordingly, the present embodiments may be used to create a photonic-matter interface that efficiently converts quantum information between photonic qubits and matter-based qubits (e.g., trapped ions, neutral atoms, defects in diamond, quantum dots, etc.). Such an optical coupling system could increase the number of qubits in a quantum computer, thereby improving qubit scaling. For example, the optical coupling setup could be used to efficiently transfer optical information between spatially disparate ion traps, thereby enabling quantum computing beyond the melting-size limit of a single ion crystal.

Another application of the present embodiments is sensing with color centers.

Here, the optical cavity improves light gathering, thereby enabling faster, more accurate readout of the color-center state. Such a scanning-cavity microscope would rely upon the a small waist w₀ rather than high finesse, greatly relaxing material constraints. As another application, the optical cavity could be used for an orders-of-magnitude speed-up in state detection for atom-array quantum simulators and computers, thereby enabling optically-mediated non-local gates and real-time feedback-based error correction.

FIG. 1 is a side view of an optical cavity array 100 that forms a plurality of longitudinal modes 140 that are transversely non-degenerate, in embodiments. FIG. 2 is a side view of the optical cavity array 100 of FIG. 1, showing in more detail how each of the longitudinal modes 140 forms a respective one of a plurality of foci 130 at a focal plane 108.

FIGS. 1 and 2 are best viewed together with the following description.

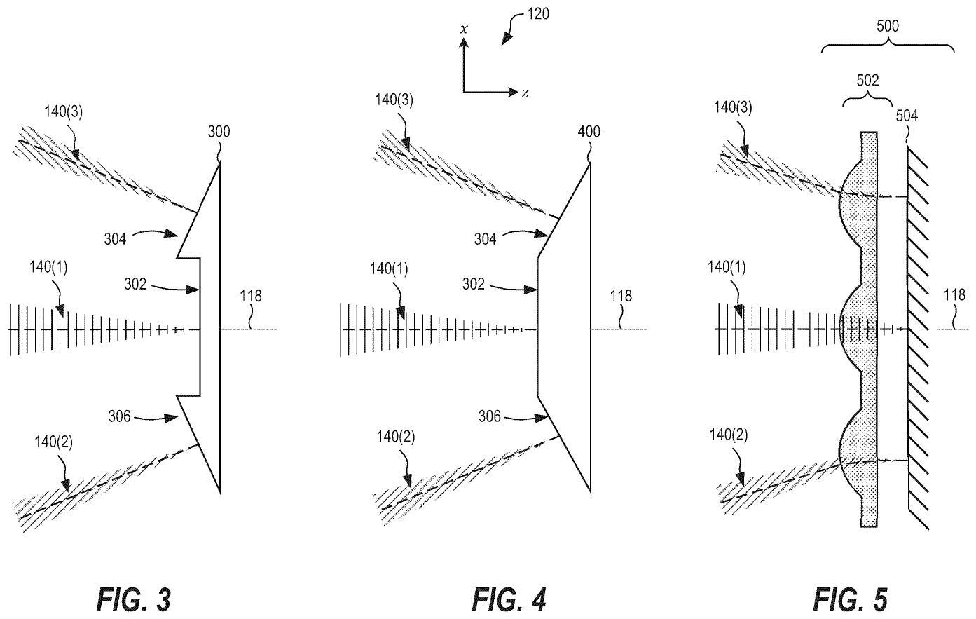

The optical cavity array 100 includes a first mirror 102 and a second mirror 116 that face each other to form a Fabry-Perot cavity. The mirrors 102 and 116 are counterfacing retroreflectors whose positions define an optical axis 118 that is parallel to z (see right-handed coordinate system 120). For clarity, directions along x and y are also referred to as “transverse” while directions along z are referred to as “longitudinal” or “axial.” In the example of FIG. 1, the first mirror 102 is a planar mirror lying perpendicular to the optical axis 118. However, the first mirror 102 may have a different geometry, as described in more detail below. More details about the geometry of the second mirror 116 are described below with regards to FIGS. 3-7.

The optical cavity array 100 also includes a first lens system 122 that is located axially between the mirrors 102 and 118. The first lens system 122 has a first input that faces in the +z direction (i.e., toward the second mirror 116) and a first output that faces in the −z direction (i.e., toward the first mirror 102). In the example of FIG. 1, a first lens 106 defines the first input and a second lens 104 defines the first output. The optical cavity array 100 also includes a second lens system 124 that is located axially between the first lens system 122 and the second mirror 116. The second lens system 124 has a second input that faces the first input (i.e., the first lens 106) and a second output that faces the second mirror 116. In the example of FIG. 1, a third lens 110 defines the second input and a fourth lens 112 defines the second output.

The first and second inputs (i.e., the lenses 106 and 110) are axially separated, forming a focal plane 108 therebetween. The first lens 106 has a first focal length f₁ while the second lens 104 has a second focal length f₂ that, in the example of FIG. 1, is greater than the first focal length f₁. The face of the first lens 106 closest to the focal plane 108 is located a first working distance WD₁ therefrom. In general, the first working distance WD₁ does not equal the first focal length f₁, but may depend on the focal lengths f₁ and f₂ and a first lens spacing D₁ between the lenses 104 and 106, among other parameters. The first lens system 122 has a first back distance B₁. In the example of FIG. 1, the first mirror 102 is located behind the second lens 104 at, or near, the first back distance B₁. However, it is not necessary that the first mirror 102 be located exactly at this position. In general, the first back distance B₁ does not equal the second focal length f₂. However, for f₂>>f₁ and D₁=f₁+f₂, the first back distance B₁ may have a value close to that of the second focal length f₂.

Although not labeled in FIG. 1, the second lens system 124 is similar to, but not exactly equal to, the first lens system 122. The third lens 110 has a third focal length f₃ and the fourth lens 112 has a fourth focal length f₄ that, in the example of FIG. 2, is greater than the third focal length f₃. The face of the third lens 110 closest to the focal plane 108 is located a second working distance WD₂ therefrom. The lenses 110 and 112 are axially separated by a second lens spacing D₂. The second lens system 124 has a second back distance B₂ between the fourth lens 112 and the second mirror 116.

In FIG. 1, the lenses 106 and 104 are separated by approximately the sum of their focal lengths, i.e., D₁˜f₁+f₂. However, the lenses 106 and 104 may be separated by a different value of D₁. Similarly, the lenses 110 and 112 are separated by approximately the sum of their focal lengths, i.e., D₂˜f₃+f₄. However, the lenses 110 and 112 may be separated by a different value of D₂. Also in FIG. 1, the first lens 106 has a higher NA than the second lens 104 and the third lens 110 has a higher NA than the fourth lens 112. As can be seen, the clear aperture of the second lens 104 may be larger than that of the first lens 106, especially when the first focal length f₁ is greater than the second focal length f₂. Similarly, the clear aperture of the fourth lens 112 may be greater than that of the third lens 110.

While each of the lens systems 122 and 124 is shown in FIG. 1 with two plano-convex lenses, one or both of the lens systems 122 and 124 may have more than two lens elements, other types of lens elements, or both. As known by those skilled in the art, such multi-lens systems may be used to correct for aberrations (e.g., chromatic aberration, spherical aberration, coma, astigmatism, etc.). Furthermore, the lens systems 122 and 124 are not limited to thin lenses, but may alternatively or additionally include thick lenses, compound lenses, objectives, GRIN lenses, aspheric lenses, and the like. Accordingly, one or both of the lens systems 122 and 124 may be configured differently than shown in FIG. 1 without departing from the scope hereof.

One or both of the lens systems 122 and 124 may have a finite conjugate ratio, and therefore magnification. For example, when the second lens system 124 has a finite conjugate ratio, it may be configured to image the focal plane 108 onto an image plane 114. The second mirror 116 may be located at, or near, the image plane 114. However, the second mirror 116 need not be located exactly at the image plane 114. In fact, it may be advantageous to intentional locate the second mirror 116 away from the image plane 114 to, for example, improve cavity stability, correct for aberrations, or achieve certain design specifications.

FIG. 1 shows the optical cavity array 100 supporting three longitudinal modes 140 that are transversely non-degenerate. Each of the longitudinal modes 140 corresponds to a standing wave that is resonant with the Fabry-Perot cavity. Specifically, a first longitudinal mode 140(1) spatially overlaps the optical axis 118 at all axial positions between the mirrors 102 and 116, a second longitudinal mode 140(2) is located transversely above (i.e., in the +x direction) the optical axis 118 between the first mirror 102 and the focal plane 108, and a third longitudinal mode 140(3) is located transversely below (i.e., in the −x direction) the optical axis 118 between the first mirror 102 and the focal plane 108. Between the focal plane 108 and the second mirror 116, the second longitudinal mode 140(2) and the third longitudinal mode 140(3) are reversed, with the second longitudinal mode 140(2) lying below the optical axis 118 and the third longitudinal mode 140(3) lying above the optical axis 118.

In FIGS. 1 and 2, each longitudinal mode 140 is represented by a shaded region that indicates how its spot size (i.e., transverse dimension along x) varies with axial position z. It is assumed that each longitudinal mode 140 is in a TEM₀₀ transverse mode. Accordingly, the transverse intensity profile of each longitudinal mode 140 is Gaussian and the spot size may be a 1/e² intensity radius or diameter of the Gaussian intensity profile.

FIG. 2 shows how each longitudinal mode 140 forms a focus 130 on, or near, the focal plane 108. Specifically, the first longitudinal mode 140(1) forms a first focus 130(1) that coincides with the optical axis 118, the second longitudinal mode 140(2) forms a second focus 130(2) that is located transversely above the optical axis 118, and the third longitudinal mode 140(3) forms a third focus 130(3) that is located transversely below the optical axis 118. Thus, the foci 130(1), 130(2), and 130(3) are transversely separated. For clarity in FIG. 2, each of the foci 130 is enclosed by a small circle.

For clarity in FIGS. 1 and 2, the transverse center (i.e., point of highest intensity) of each of the longitudinal modes 140(1), 140(2), and 140(3) is identified with a dashed line. These dashed lines are also referred to as center axes of the longitudinal modes 140. As can be seen in FIG. 2, these center axes do not intersect at the focal plane 108. Rather, the point where they intersect is located a distance Δz from the focal plane 108. It is believed that this feature arises from the lens systems 122 and 124 being dissimilarly configured and is related to the ability of the optical cavity array 100 to form longitudinal modes that are transversely non-degenerate. Accordingly, if the lens systems 122 and 124 were configured identically, Δz would be zero and the optical cavity array 100 would no longer be able to support transversely non-degenerate longitudinal modes (i.e., the longitudinal modes 140 would all “collapse” into one degenerate mode, similar to prior-art Fabry-Perot cavities).

There are many ways in which the lens systems 122 and 124 may be configured dissimilarly. For example, the lenses 104, 106, 110, and 112 may be selected such that D₁≠D₂, WD₁≠WD₂, B₁≠B₂, or a combination thereof. In another example, the first mirror 102 is axially positioned away from the back distance B₁ from the second lens 104. Similarly, the second mirror 116 may be axially positioned away form the back distance B₂. In another example, the lenses 104 and 106 are positioned such that D₁≠f₁+f₂. Similarly, the lenses 110 and 112 may be positioned such that D₂≠f₃+f₄.

For clarity, only three foci 130(1), 130(2), and 130(3) are shown in FIG. 2. However, the optical cavity array 100 may alternatively form only two foci 130 or more than three foci 130. While the foci 130 are shown in FIGS. 1 and 2 as extending along x, the foci 130 may alternatively or additionally extend along y. The number of foci 130 formed by the optical cavity array 100 may be as large as several hundred, if not more.

For each longitudinal mode 140 to have its waist (i.e., smallest spot size) at its respective focus 130 in the focal plane 108, each of the lenses 106 and 110 may have a high NA (e.g., 0.5 or more). As can be seen in FIG. 1, the spot size of each longitudinal mode 140 is also small at the mirrors 102 and 116. However, due to the relationship between the NAs of the lenses 104, 106, 110, and 112, the spot sizes of the longitudinal modes 140 may be larger at the mirrors 102 and 116 than at the focal plane 108. In general, one or both of the lenses 106 and 110 may have an NA less than 0.5 without departing from the scope hereof.

As can be seen in FIG. 1, the transverse spacing of the longitudinal modes 140 is greater at the mirrors 102 and 116 than at the focal plane 108. The transverse spacing is measured between the center axes of neighboring longitudinal modes 140 (i.e., between dashed lines). It is believed that this effect arises from magnification of the lens systems 122 and 124. Specifically, the first lens system 122 has a first magnification M₁>1 for light propagating therethrough in the −z direction. Similarly, the second lens system 122 has a second magnification M₂>1 for light propagating therethrough in the +z direction. The longitudinal modes 140 have a first transverse spacing d₁ at the first mirror 102 and a second transverse spacing d₂ at the second mirror 116. In FIG. 1, d₁>d₂, which may arise when M₁>M₂. However, the lens systems 122 and 124 may be alternatively configured such that d₂<d₁.

One advantage to having transverse spacings that are larger at the mirrors 102 and 116, as compared to the focal plane 108, is ease of coupling light into the optical cavity array 100. The longitudinal modes 140 may be excited, for example, by transmitting light through one of the mirrors 102 and 116. The light may be a single monochromatic laser beam with a spot size large enough to cover all of the longitudinal modes. Alternatively, the light may be several smaller monochromatic laser beams that are transversely displaced from each other. Each of these several laser beams may be individually controlled (e.g., intensity, propagation direction, etc.) for coupling into a respective one of the longitudinal modes 140. Such individual control may be easier to implement when the several laser beams are displaced from each other by larger transverse distances.

Another advantage to having transverse spacings that are larger at the mirrors 102 and 116 is processing light that leaks out of the optical cavity array 100. This leakage light may come from the longitudinal modes 140 or fluorescence emitted into the longitudinal modes 140 by quantum emitters either located at, or trapped in, the waists. Leakage light leaves the optical cavity array 100 via transmission through one or both of the mirrors 102 and 116. Alternatively or additionally, light can be coupled out of the optical cavity array 100 with an intracavity beam sampler. To minimize aberrations, this beam sampler may be placed in a low-NA region of the optical cavity array 100 (e.g., between the fourth lens 112 and the second mirror 116 or between the second lens 104 and the first mirror 102). In any case, it may be necessary to process leakage light differently, depending on which of the longitudinal modes 140 it came from. This different processing can be facilitated by spatially separating the leakage light, which is easier to do when the transverse spacings are larger.

While FIG. 1 shows the optical cavity array 100 with the mirrors 102 and 116 forming a Fabry-Perot cavity, the optical cavity array 100 may alternatively have three or more mirrors positioned and oriented to form a ring cavity. In this case, each of the three or more mirrors may be a turning mirror, as opposed to a retroreflector. The ring cavity also supports a plurality of longitudinal modes. However, in this case each longitudinal mode corresponds to a traveling wave, as opposed to a standing wave.

FIG. 3 is a side view of a polygonal mirror 300 that is one example of the second mirror 116 of FIG. 1. The polygonal mirror 300 has a first face 304 that forms a first oblique angle with the optical axis 118, a second face 302 that is perpendicular to the optical axis 118, and a third face 306 that forms a second oblique angle with the optical axis 118. The faces 302, 304, and 306 are positioned to retroreflect light thereon back onto itself. More specifically, the first oblique angle is selected such that the third longitudinal mode 140(3) retroreflects off the first face 304. Similarly, the second oblique angle is selected such that the second longitudinal mode 140(2) retroreflects off the third face 306. The polygonal mirror 300 may be shaped with additional faces for when there are more than three longitudinal modes 140. The second face 302 is the portion of the polygonal mirror 300 that cooperates with the first mirror 102 to define the optical axis 118.

FIG. 4 is a side view of a polygonal mirror 400 that is similar to the polygonal mirror 300 of FIG. 3 except that the second face 302 is not axially recessed. Specifically, the second face 302 is located farther in the −z direction in the polygonal mirror 400, as compared to the polygonal mirror 300. Without this recess, the polygonal mirror 400 may be easier to fabricate than the polygonal mirror 300.

FIG. 5 is a side view of a cat's-eye retroreflector array 500 that is another example of the second mirror 116 of FIG. 1. The cat's-eye retroreflector array 500 includes a microlens array 502 that extends in one or both of the two transverse dimensions (i.e., x and y).

Each longitudinal mode 140 uniquely interacts with one microlens of the array 502. The microlens array 502 focuses the longitudinal modes 140 such that their center axes are all parallel to the optical axis 118. As a result, the longitudinal modes 140 can be reflected using a planar mirror 504 that is located behind (i.e., in the +z direction) the microlens array 502 and oriented perpendicular to the optical axis 118.

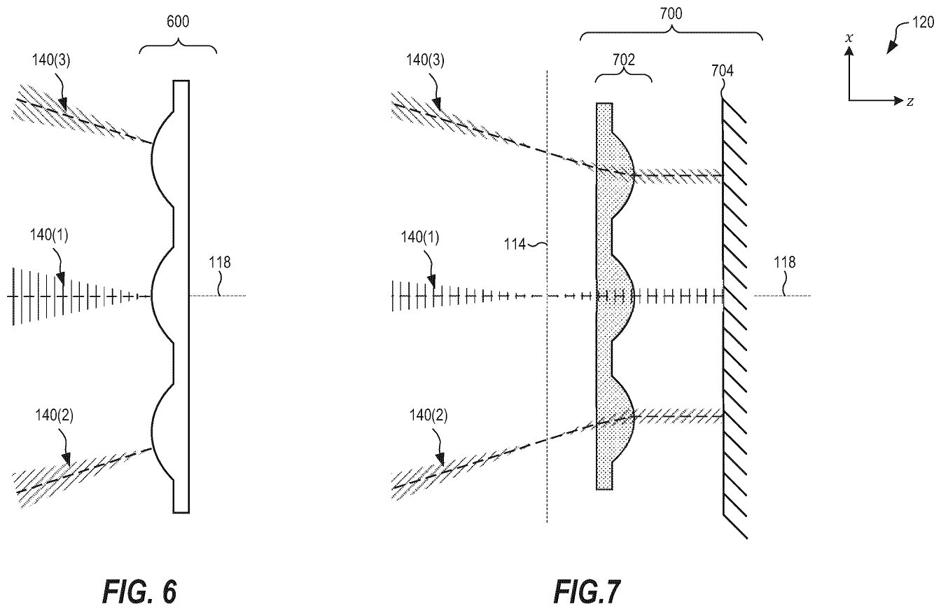

FIG. 6 is a side view of a convex micromirror array 600 that is another example of the second mirror 116 of FIG. 1. The micromirror array 600 is a one or two dimensional array of convex mirrors that may be fabricated, for example, by depositing a high-reflectivity coating on the convex surfaces of a microlens array (e.g., the microlens array 502 of FIG. 5). As can be seen in FIG. 6, the micromirror array 600 is configured to retroreflect the longitudinal modes 140 regardless of their different angles of incidence.

FIG. 7 is a side view of a retroreflector array 700 that is another example of the second mirror 116 of FIG. 1. The retroreflector array 700 includes a microlens array 702 that is similar to the microlens array 502 of FIG. 5 except that it is located axially past the image plane 114 in the +z direction. The microlens array 702 collimates the longitudinal modes 140 and deflects the longitudinal modes 140 such that their center axes are parallel to the optical axis 118. In this case, a planar mirror 704 oriented perpendicular to the optical axis 118 can be used to retroreflect the longitudinal modes 140.

Depending upon the quality of the optics, it may be necessary to individually tune the resonant frequency of each longitudinal mode 140. Such tuning may be used, for example, to ensure that atoms emit fluorescence that is resonant with the longitudinal mode 140 within which it is trapped. This can be achieved, for example, with a phase-only spatial light modulator placed in a low-NA region of the optical cavity array 100 (e.g., between the fourth lens 112 and the second mirror 116 or between the second lens 104 and the first mirror 102). Alternatively, once the necessary phase shifts are determined, a custom antireflection-coated phase mask could be installed within the optical cavity array 100, which might advantageously incur lower optical insertion loss than a spatial light modulator.

When the optical cavity array 100 is excited with light (as described above), an optical dipole trap is formed at each of the foci 130. The optical dipole trap may be a standing-wave optical lattice or traveling-wave optical tweezer. The resulting plurality of optical dipole traps may be used to trap cold or ultracold atoms, or another type of optically trappable quantum emitter. Advantageously, these optical dipole traps are located sufficiently far from nearby physical surfaces (e.g., the lenses 106 and 110) to ensure that the trapped atoms will not be ejected upon colliding with such a surface. Once the atoms are trapped, they may then be driven, measured, coupled, probed, or otherwise manipulated as needed for the application at hand. For example, fluorescence can be collected from at least one atom trapped in one of the optical dipole traps. As described above, the fluorescence can couple into one of the longitudinal modes 140, from which it may be transmitted through one of the mirrors 102 and 116.

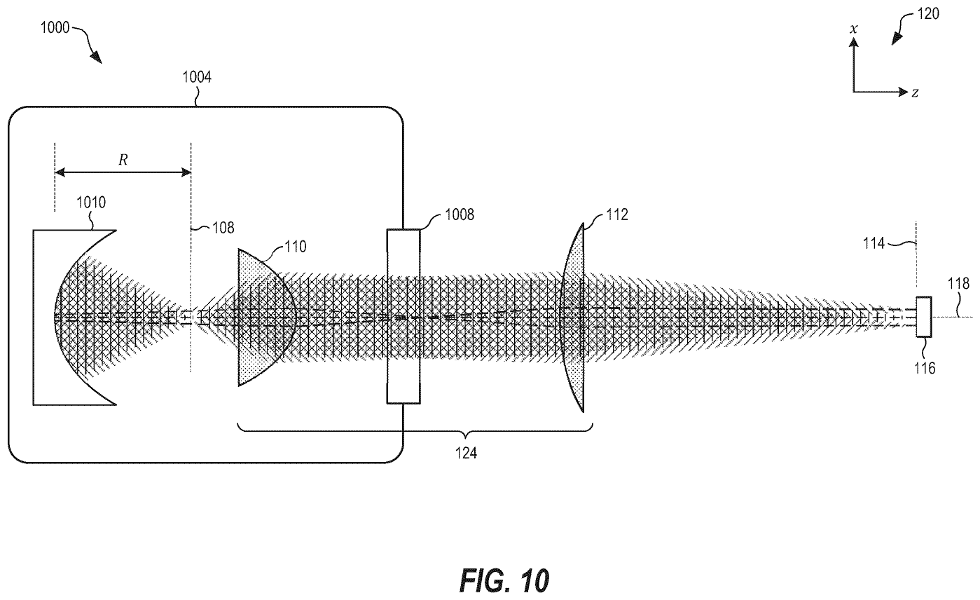

To further facilitate cold-atom trapping, the optical cavity array 100 may be arranged such that the array of foci 130 is located inside an ultra-high vacuum environment. However, some conventional vacuum chambers are so large that the lenses 106 and 110 cannot be placed outside of the vacuum chamber, as they will then be too far apart from each other to produce foci 130 (i.e., waists) that are tight enough for the application at hand. In such situations, the lenses 106 and 110 can be brought closer to each other by mounting one or both of them inside the vacuum chamber (e.g., see FIG. 10). Additional components of the optical cavity array 100 may be mounted inside the vacuum chamber. Vacuum windows may be used to on the vacuum system to allow light to pass therethrough.

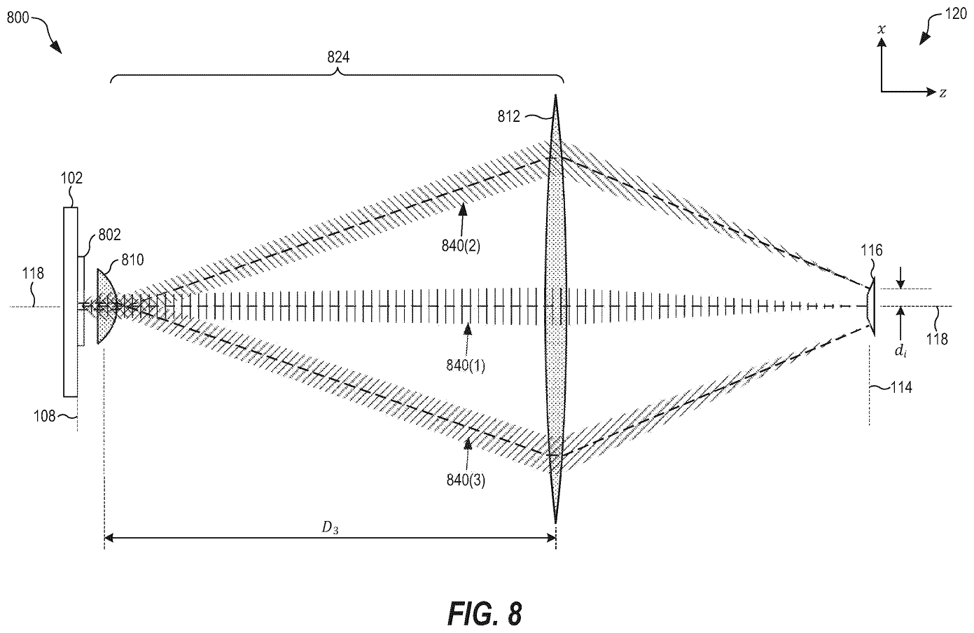

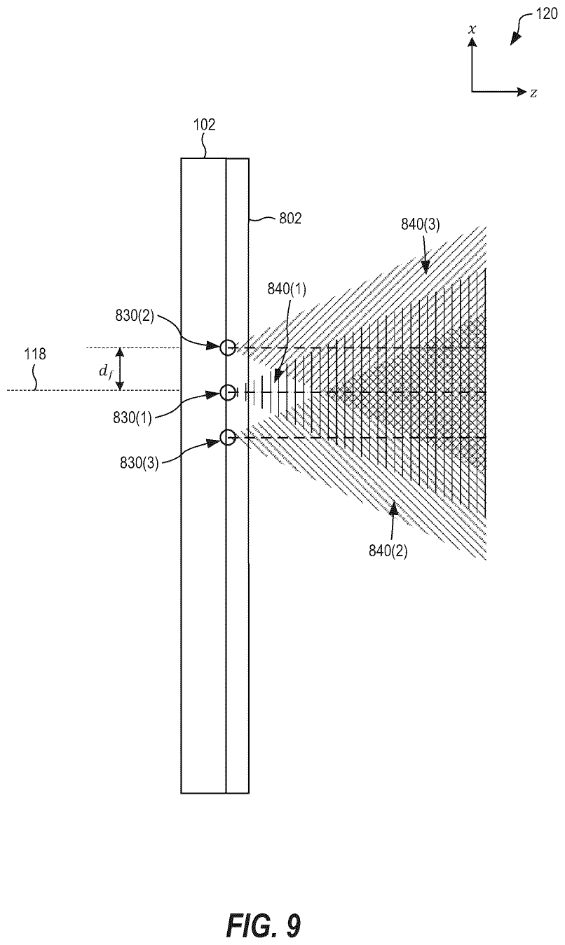

FIG. 8 is a side view of an optical cavity array 800 that is similar to the optical cavity array 100 of FIG. 1 except that the first lens system 122 is excluded and the first mirror 102 is located at, or near, the focal plane 108. FIG. 9 is a side view of the optical cavity array 800 of FIG. 8, showing in more detail how foci 830 are located near the first mirror 102. FIGS. 8 and 9 are best viewed together with the following description.

The optical cavity array 800 is advantageous for quantum emitters that are solid-state, and therefore do not need to be magnetically or optically trapped. In FIGS. 8 and 9, a sample of non-linear emitters 802 (e.g., a wafer or substrate) is affixed to the front face of the first mirror 102. Examples of such non-linear emitters 802 include, but are not limited to, rare-earth ions, quantum dots, solid-state color centers (e.g., silicon vacancy centers in diamond, nitrogen vacancy centers in diamond, etc.) and molecules embedded in a host matrix.

The optical cavity array 800 includes a lens system 824 that projects the focal plane 108 onto the image plane 114. FIGS. 8 and 9 show a first longitudinal mode 840(1) with a first focus 830(1), a second longitudinal mode 840(2) with a second focus 830(2), and a third longitudinal mode 840(3) with a third focus 830(3). The longitudinal modes 840(1), 840(2), and 840(3) are transversely non-degenerate and therefore do not couple to each other. Accordingly, the foci 830(1), 830(2), and 830(2) are spatially separated, as shown in FIG. 9.

The lens system 824 includes a first lens 810 that is closer to the focal plane 108 and a second lens 812 that is closer to the image plane 114. Unlike the second lens system 124 of FIG. 1, the lens system 824 of FIG. 8 is configured such that the center axes of the longitudinal modes 840(1). 840(2), and 840(3) are parallel to the optical axis 118. As a result, the first mirror 102 retroreflects the longitudinal modes 840 at the focal plane 108. While FIGS. 8 and 9 show only three longitudinal modes 840, the optical cavity array 800 may be configured to support a different number of transversely non-generate longitudinal modes.

In the example of FIGS. 8 and 9, the first lens 810 has a large NA (e.g., 0.5 or greater) that helps achieve small waists at the focal plane 108. The second lens 812 has a smaller NA than the first lens 810, but a larger clear aperture. In addition, the second lens 812 has a greater focal length than the first lens 810. The lenses 810 and 812 are separated by a lens spacing D₃ whose value may be equal to, or near, to the sum of their individual focal lengths. However, the lens spacing D₃ may a value different from this sum to ensure that the center axes are parallel to the optical axis 118 at the focal plane 108 and that all of the longitudinal modes 840 are stable. Accordingly, the lens system 824 may be configured differently than shown in FIG. 8 without departing from the scope hereof.

FIGS. 8 and 9 also show how the longitudinal modes 840 have a transverse spacing dᵢ near the image plane 114 that is larger than a transverse spacing d_{f} near the focal plane 108. Similar to the case described above with regards to FIGS. 1 and 2, it is believed that these different transverse spacings arise from magnification of the lens system 824. Accordingly, the lens system 824 may be configured with magnification to achieve this effect.

While FIG. 8 shows the lens system 824 with two piano-convex lenses, the lens system 824 may alternatively have more than two lenses, different types of lenses, or both. Such a multi-lens system may be used to correct for aberrations. Furthermore, the lens system 824 is not limited to thin lenses, but may alternatively or additionally include thick lenses, compound lenses, objectives, GRIN lenses, aspheric lenses, and the like.

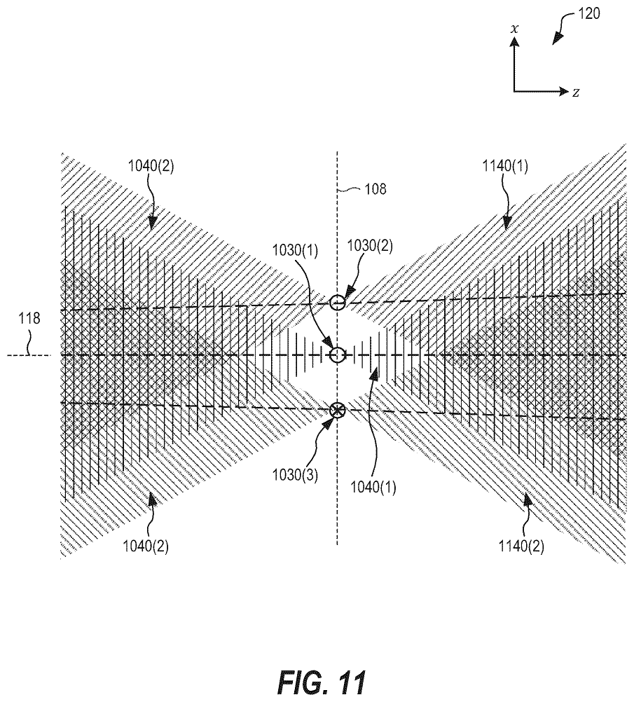

FIG. 10 is a side view of an optical cavity array 1000 that is similar to the optical cavity array 100 of FIG. 1 except that the first lens system 122 and first mirror 102 are replaced by a curved mirror 1010. FIG. 11 is a side view of the optical cavity array 1000 of FIG. 10, showing in more detail how foci 1030 are located at the focal plane 108. FIGS. 10 and 11 are best viewed together with the following description.

In FIG. 10, the curved mirror 1010 is a concave spherical mirror with a radius of curvature R. The curved mirror 1010 is axially located at, or near, a distance R from the focal plane 108. However, to ensure stability and the formation of transversely non-degenerate longitudinal modes, the curved mirror 1010 need not be located at exactly the distance R from the focal plane 108.

FIGS. 10 and 11 show the optical cavity array 1000 supporting a first longitudinal mode 1040(1) that is transversely centered on the optical axis 118. Near the focal plane 108, the first longitudinal mode 1040(1) has a first focus 1030(1) that is located where the focal plane 108 and optical axis 118 intersect. The optical cavity array 1000 also supports a second longitudinal mode 1040(2) having a top leg 1140(1) and a bottom leg 1140(2). Near the focal plane 108, the top leg 1140(1) is transversely above (i.e., in the +x direction) the optical axis 118, where it forms a second focus 1030(2) that is transversely separated from the first focus 1030(1). Also near the focal plane 108, the bottom leg 1140(2) is transversely below (i.e., in the −x direction) the optical axis 118, where it forms a third focus 1030(3) that is also transversely separated from the first focus 1030(1).

In FIG. 11, the center axis of the first longitudinal mode 1040(1) coincides with the optical axis 118 and therefore is parallel to the optical axis 118. However, the center axes of the legs 1140(1) and 1140(2) are not parallel to the optical axis 118. As shown, the center axes at a point behind the curved mirror 1010 (i.e., in the −z direction relative to the curved mirror 1010). The curved mirror 1010 reflects the top leg 1140(1) downward (i.e., in the −x direction) for a short distance before reflecting it again to form the bottom leg 1140(2). Thus, the curved mirror 1010 does not fully retroreflect the second longitudinal mode 1040(2), but rather translates it along x such that the top leg 1140(1) and bottom leg 1140(2) are transversely separated from each other. Accordingly, the top leg 1140(1) and bottom leg 1140(2) exhibit mirror symmetry about the optical axis 118.

Since the foci 1030(2) and 1030(3) are both part of the second longitudinal model 1040(2), atoms trapped at these two foci will be coupled to each other. To avoid this coupling, atoms should not be trapped at one of these two foci. In FIG. 11, the third foci 1030(3) is shown with an “x” to indicate that it may be excluded for trapping. Alternatively, the first foci 1030(1) could be excluded. Thus, of the three foci 1030(1), 1030(2), and 1030(3), at most two can be used for atom trapping without coupling. Extending this to N transversely non-degenerate longitudinal modes 1040, the optical cavity array 1000 forms 2N−1 foci 1030, of which at most N can be used for atom trapping without coupling between traps.

In FIG. 10, the center axes of the longitudinal modes 1040 need not all be parallel to the optical axis 118 near the second mirror 116. Accordingly, the second mirror 116 may be the polygonal mirror 300 of FIG. 3, the polygonal mirror 400 of FIG. 4, the cat's-eye retroreflector array 500 of FIG. 5, the micromirror array 600 of FIG. 6, the retroreflector array 700 of FIG. 7, or a another type of retroreflector known in the art. Furthermore, since the curved mirror 1010 does not retroreflect any of the longitudinal modes 1040 that are transversely shifted off the optical axis 118, the second mirror 116 retroreflects each of these off-axis longitudinal modes 1040 twice (as opposed to once in the optical cavity array 100 of FIG. 1).

FIG. 10 also shows how the present embodiments can be mounted inside of a vacuum chamber 1004. In this example, the curved mirror 1010 and third lens 110 are located inside the vacuum chamber 1004, where they can be placed close (e.g., within millimeters) to the focal plane 108 to ensure high-NA waist formation and fluorescence collection. The fourth lens 112 and second mirror 116 are located outside of the vacuum chamber 1004. A vacuum window 1008 provides optical access between those components inside the vacuum chamber 1004 and those outside the vacuum chamber 1004. The vacuum window 1008 may be located in a low-NA region of the optical cavity array 1000. For example, in FIG. 10 the vacuum window 1008 is located between the lenses 110 and 112. Alternatively, the vacuum window 1008 could be located between the lens 112 and the second mirror 116, in which case the lens 112 would be inside the vacuum chamber 1004.

Alternatively, the lens 112 and second mirror 116 could also be located inside the vacuum chamber 1004, in which case the vacuum window 1008 is not located inside the optical cavity array 1000. In fact, the vacuum window 1008 may not be needed in this case, such as when light for coupling into the optical cavity array 1000 is guided into the vacuum chamber 1004 via an optical fiber. However, the vacuum window 1008 could still be used, for example, to couple a free-space light beam into the optical cavity array 1000, collecting light from the optical cavity array 1000, or both.

### COMBINATIONS OF FEATURES

Features described above as well as those claimed below may be combined in various ways without departing from the scope hereof. The following examples illustrate possible, non-limiting combinations of features and embodiments described above. It should be clear that other changes and modifications may be made to the present embodiments without departing from the spirit and scope of this invention:

(A1) An optical cavity array includes a plurality of mirrors positioned and oriented to form an optical cavity. The optical cavity array also includes a first lens system located within the optical cavity. The first lens system has a first output facing a first mirror of the plurality of mirrors and a first input facing a second mirror of the plurality of mirrors. The optical cavity array also includes a second lens system located within the optical cavity. The second lens system has a second input facing the first input of the first lens system and a second output facing the second mirror. The optical cavity supports a plurality of longitudinal modes that are transversely non-degenerate and form a corresponding plurality of foci that lie along a focal plane axially located between the first input of the first lens system and the second input of the second lens system.

(A2) In the optical cavity array denoted (A1), the plurality of mirrors include three or more mirrors forming a ring cavity. Each of the plurality of longitudinal modes corresponds to a traveling wave that propagates around the ring cavity.

(A3) In the optical cavity array denoted (A1), the first and second mirrors are first and second retroreflectors, respectively, that face each other to form a Fabry-Perot cavity. Each of the plurality of longitudinal modes corresponds to a standing wave that is resonant with the Fabry-Perot cavity.

(A4) In the optical cavity array denoted (A3), the second lens system images the focal plane onto an imaging plane. The second retroreflector is axially located near the imaging plane.

(A5) In either of the optical cavity arrays denoted (A3) and (A4), the second retroreflector is a polygonal mirror, a cat's-eye array, or a convex mirror array.

(A6) In any of the optical cavity arrays denoted (A3) to (A5), the first retroreflector is a planar mirror oriented perpendicular to an optical axis of the optical cavity.

(A7) In any of the optical cavity arrays denoted (A3) to (A6), the first lens systems includes a first lens having a first focal length f₁ and a second lens having a second focal length f₂. The second lens is axially located behind the first lens by f₁+f₂.

(A8) In the optical cavity array denoted (A7), the second focal length f₂ is greater than the first focal length f₁.

(A9) In either of the optical cavity arrays denoted (A7) and (A8), the first lens has a greater numerical aperture than the second lens.

(A10) In any of the optical cavity arrays denoted (A7) to (A9), the second lens system includes a third lens having a third focal length f₃ and a fourth lens having a fourth focal length f₄. The fourth lens is axially located behind the third lens by f₃+f₄.

(A11) In the optical cavity array denoted (A10), the fourth focal length f₄ is greater than the third focal length f₃.

(A12) In either of the optical cavity arrays denoted (A10) and (A11), the third lens has a greater numerical aperture than the fourth lens.

(A13) In any of the optical cavity arrays denoted (A1) to (A12), each of the first and second lens systems has a finite conjugate ratio.

(A14) In any of the optical cavity arrays denoted (A1) to (A13), the optical cavity array further includes a vacuum chamber. The focal plane lies within the vacuum chamber.

(A15) In the optical cavity array denoted (A14), one or both of the first and second mirrors is located inside the vacuum chamber.

(A16) In any of the optical cavity arrays denoted (A1) to (A15), the optical cavity array further includes a phase plate or phase modulator located within the optical cavity.

(B1) A method includes coupling laser light into any one of the optical cavity arrays denoted (A1) to (A16) to excite the plurality of longitudinal modes.

(B2) In the method denoted (B1), each of the plurality of longitudinal modes, when excited, forms a respective one a plurality of optical dipole traps located at the focal plane. The method further includes trapping at least one atom in each of one or more of the plurality of optical dipole traps.

(B3) In the method denoted (B2), the method further includes collecting fluorescence emitted by at least one atom trapped in one of the plurality of optical dipole traps, the fluorescence being transmitted through one of the first and second mirrors of the optical cavity array.

(B4) In any of the methods denoted (B1) to (B3), the method further includes changing an optical path length of only one of the plurality of longitudinal modes.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. An optical cavity array, comprising:
a plurality of mirrors positioned and oriented to form an optical cavity;
a first lens system located within the optical cavity, the first lens system having a first output facing a first mirror of the plurality of mirrors, the first lens system having a first input facing a second mirror of the plurality of mirrors; and
a second lens system located within the optical cavity, the second lens system having a second input facing the first input of the first lens system and a second output facing the second mirror;
wherein the optical cavity supports a plurality of longitudinal modes that are transversely non-degenerate and form a corresponding plurality of foci that lie along a focal plane axially located between the first input of the first lens system and the second input of the second lens system.

2. The optical cavity array of claim 1, wherein:
the plurality of mirrors include three or more mirrors forming a ring cavity; and
each of the plurality of longitudinal modes corresponds to a traveling wave that propagates around the ring cavity.

3. The optical cavity array of claim 1, wherein:
the first and second mirrors are first and second retroreflectors, respectively, that face each other to form a Fabry-Perot cavity; and
each of the plurality of longitudinal modes corresponds to a standing wave that is resonant with the Fabry-Perot cavity.

4. The optical cavity array of claim 3, wherein:
the second lens system images the focal plane onto an imaging plane; and
the second retroreflector is axially located near the imaging plane.

5. The optical cavity array of claim 3, the second retroreflector comprising a polygonal mirror, a cat's-eye array, or a convex mirror array.

6. The optical cavity array of claim 3, the first retroreflector comprising a planar mirror oriented perpendicular to an optical axis of the optical cavity.

7. The optical cavity array of claim 3, the first lens system comprising:
a first lens having a first focal length f₁; and
a second lens having a second focal length f₂, the second lens being axially located behind the first lens by f₁+f₂.

8. The optical cavity array of claim 7, the second focal length f₂ being greater than the first focal length f₁.

9. The optical cavity array of claim 7, the first lens having a greater numerical aperture than the second lens.

10. The optical cavity array of claim 7, the second lens system comprising:
a third lens having a third focal length f₃; and
a fourth lens having a fourth focal length f₄, the fourth lens being axially located behind the third lens by f₃+f₄.

11. The optical cavity array of claim 10, the fourth focal length f₄ being greater than the third focal length f₃.

12. The optical cavity array of claim 10, the third lens having a greater numerical aperture than the fourth lens.

13. The optical cavity array of claim 1, each of the first and second lens systems having a finite conjugate ratio.

14. The optical cavity array of claim 1, further comprising a vacuum chamber, the focal plane lying within the vacuum chamber.

15. The optical cavity array of claim 14, one or both of the first and second mirrors being located inside the vacuum chamber.

16. The optical cavity array of claim 1, further comprising a phase plate or phase modulator located within the optical cavity.

17. A method, comprising coupling laser light into the optical cavity array of claim 1 to excite the plurality of longitudinal modes.

18. The method of claim 17, wherein:
each of the plurality of longitudinal modes, when excited, forms a respective one a plurality of optical dipole traps located at the focal plane; and
the method further includes trapping at least one atom in each of one or more of the plurality of optical dipole traps.

19. The method of claim 18, further comprising collecting fluorescence emitted by at least one atom trapped in one of the plurality of optical dipole traps, the fluorescence being transmitted through one of the first and second mirrors of the optical cavity array.

20. The method of claim 17, further comprising changing an optical path length of only one of the plurality of longitudinal modes.
